(19) United States
(12) Patent Application Publication
(10) Pub. No.: US 2011/0187863 A1
(43) Pub. Date: Aug. 4, 2011

(54) METHOD FOR DETECTING EXPANSIVE STATIC OBJECTS

(75) Inventors: Karl-Heinz Glander, Backhang (DE); Gregory Baratoff, Wagen (DE)

(73) Assignee: CONTINENTAL AUTOMOTIVE GMBH, Hannover (DE)

(21) Appl. No.: 13/058,275

(22) PCT Filed: Jul. 8, 2009
(86) PCT No.: PCT/DE2009/000955

§ 371 Date: Apr. 22, 2011

(30) Foreign Application Priority Data
Aug. 12, 2008 (DE) 10 2008 038 731.2

(51) Int. Cl. H04N 7/18

(52) U.S. Cl. 348/148; 348/E07.085

(57) ABSTRACT

A method for detecting expansive static objects from a vehicle in motion. For this purpose, the method employs a front camera that interacts with an image processing device. The front camera can detect road markings on the road. A lateral detection device detects objects in the blind spot of the vehicle. Additional detection devices detect minimal distances to laterally passing or following vehicles. A logic unit links the data of the image processing device of the front camera to the data of the remaining detection devices in such a manner that expansive static objects in the front detection range of the vehicle are detected and are included as such in the detection of the lateral and rear detection devices using the logic unit.

### CROSS REFERENCE TO RELATED APPLICATIONS

This application is the U.S. national phase patent application of PCT International Application No. PCT/DE2009/000955, filed Jul. 8, 2009, which claims priority to German Patent Application No. 10 2008 038 731.2, filed Aug. 12, 2008, the contents of such applications being incorporated by reference herein.

### FIELD OF THE INVENTION

The invention relates to a method for detecting expansive static objects from a vehicle in motion. For this purpose, the method employs a front camera that interacts with an image processing device. The front camera can detect road markings on the road. A lateral detection device detects objects in the blind spot of the vehicle. Additional detection devices detect minimal distances to laterally passing or following vehicles.

### BACKGROUND OF THE INVENTION

An object detection system is known from Publication DE 199 34 670 B1, which is incorporated by reference. Said object detection system supplies measured values from overlapping detector ranges by means of at least three object detectors in the front region of the vehicle. Said measured values are supplied for separate evaluation, wherein said separate evaluation refers to different distances between the front side of the vehicle and the objects that are moving at different distances in front of the vehicle.

In addition, a Lane Departure Warning System is known from Publication DE 10 2006 010 662 A1, which is incorporated by reference herein. Said Lane Departure Warning System has sensors of a front camera and of a rear camera by means of which different regions of the surroundings of the motor vehicle are covered in order to warn the driver against crossing a roadway demarcation. In addition, a method and a device for detecting objects in the surroundings of a vehicle are known from Publication DE 103 23 144 A1, which is incorporated by reference herein, in which the sensors are capable of warning the driver of decreasing distances to vehicles, in particular to vehicles in the lateral blind spot.

The known blind spot monitoring or the above-mentioned Lane Departure Warning System are radar applications that can also work with infrared or laser sensors, wherein the sensors are used for lateral and rear object detection, wherein the Lane Departure Warning System monitors the lateral and rear ranges of a vehicle and tries to decide, on the basis of the measured data, whether one's own vehicle is in a critical state caused by another vehicle, i.e. whether the other vehicle is in a blind spot of one's own vehicle or is moving at a high relative speed from behind towards one's own vehicle.

If such a critical state is detected, the driver is warned immediately. However, the driver is not supposed to be warned if non-critical objects (including, among others, overtaken static objects) are in the blind spot, for example. Depending on the design of the RADAR-based sensors or LIDAR sensors (if they are based on light radar) and of the application, the distinction between static objects and non-static or dynamic objects is not completely possible without errors so that the reliability of such systems is limited.

It is therefore necessary to improve the driver assistance functions as well as the blind spot monitoring and the Lane Departure Warning System for achieving a classification of relevant and irrelevant objects that includes as few errors as possible. So far one has tried to calculate the kinematics of the observed objects relative to the vehicle and to the road from the single measurements of the sensors in order to distinguish between static and non-static dynamic objects. Typically, the design of the lateral and rear applications in this method is cheap so that the measuring of the own speeds of such observed objects is very inaccurate.

However, the geometry of expansive objects as well as the measuring properties of the used sensors result in additional inaccuracies. For example, during the movement of a vehicle past a crash barrier, the radar reflection point positioned on the crash barrier glides over the crash barrier in such a manner that the actual relative speed between one's own vehicle and the crash barrier is often underestimated systematically.

### SUMMARY OF THE INVENTION

It is an object of the invention to improve the distinction between static objects and non-static objects for driver assistance functions, in particular for the detection of crash barriers, walls, sidewalks, fences, and other expansive static objects.

According to aspects of the invention, a method for detecting expansive static objects from a vehicle in motion is provided. For this purpose, the method employs a front camera that interacts with an image processing device. The front camera can detect road markings on the road. A lateral detection device detects objects in the blind spot of the vehicle. Additional detection devices detect minimal distances to laterally passing or following vehicles. A logic unit links the data of the image processing device of the front camera to the data of the remaining detection devices in such a manner that expansive static objects in the front detection range of the vehicle are detected and are included as such in the detection of the lateral and rear detection devices using the logic unit.

The use of a front camera with an image processing device and of a logic unit provides the advantage of linking the data of the image processing device of the front camera to the data of the remaining detection devices in such a manner that the detection of expansive static objects is improved. Here, the camera monitors the forward range of one's own vehicle and detects expansive static objects that are present in front of the vehicle and is already provided with an application for the detection of road markings. The image processing programs and the algorithms for the detection of road markings supply information about objects to radar-based or lidar-based lateral and rear applications, said information corresponding to certain hypotheses of expansive static objects.

Not only long objects of the road markings are detected, but also crash barriers and walls that are arranged parallel to the roadway and eventually enter the sensitive range of the RADAR sensors and LIDAR sensors during the movement of the vehicle past them. This additional information about expansive long static targets of the front camera that approach one's own vehicle from the front are merged in such a manner that the object detection of the RADAR-based or LIDAR-based applications for expansive long static objects is improved, thereby preventing such objects from causing any false warnings or irritating false alarms.

The objects transmitted by the front camera appear in the lateral and rear detection ranges of the RADAR sensors or LIDAR sensors only later, which means that each of these objects can be used as an object candidate within the RADAR or LIDAR application, wherein the method is not dependent on the overlapping of the detection ranges of the front camera and of the lateral and rear RADAR sensors or LIDAR sensors; extrapolations are sufficient here. Thus, the time required for the classification of the detected objects can be reduced advantageously. In addition, the number of wrong classifications of static and dynamic objects can be reduced. In all, the distinction between static objects and non-static or dynamic objects is improved. In addition, the response time of the application can be reduced advantageously.

In a preferred implementation of the method, the front camera with an image processing device distinguishes between oncoming expansive static objects and dynamic objects, such as vehicles, and marks detected expansive static objects and forwards the result of the evaluation or this information to the logic unit for inclusion in the evaluation of the lateral and rear measuring results of the detection devices.

Advantageously, the front camera with image processing can detect the period of time during which the expansive static object is detected and algorithmically tracked and forward said period of time to the logic unit for supporting the lateral and rear detection devices. In addition, in a further implementation of the method, the front camera with an image processing device can detect and forward horizontal place coordinates of expansive static objects. In addition, horizontal components of speed regarding expansive and static objects can be detected and forwarded by means of the front camera. Now it is also possible, in an improved manner, to detect and forward classifications regarding expansive static objects made by the lateral and rear detection units on account of the results delivered by the front camera with an image processing device. Finally, the front camera with an image processing device can also detect and forward surroundings criteria regarding expansive static objects.

Since the detection ranges of the front camera and the detection ranges of the lateral and rear detection devices do not overlap in the inventive method, the vehicle-speed-dependent time delays that occur until the detected expansive static objects enter the lateral and rear detection ranges are taken into account by the logic unit in the evaluation, wherein road markings, crash barriers, walls, fences and sidewalks that enter the lateral and rear detection ranges are detected as long static objects by the front camera with an image processing device already and forwarded, via the logic unit, for detection devices that are based on radar detection or lidar detection in the lateral and rear detection ranges.

An appropriate logic device is advantageously integrated into an existing vehicle guiding system so that it is often not necessary to complement the hardware with respect to its computing capacity, storage capacity and logic operations if the reserves of the existing vehicle guiding system can be used for this improved method for the detection and classification of static and long objects.

### BRIEF DESCRIPTION OF THE DRAWINGS

The invention is best understood from the following detailed description when read in connection with the accompanying drawings. Included in the drawings is the following figures:

FIG. 1 shows a schematic top view of a vehicle that is equipped for the implementation of the method according to aspects of the invention.

FIG. 2 shows a schematic top view of a road with a vehicle according to FIG. 1.

### DETAILED DESCRIPTION OF THE PREFERRED EMBODIMENTS

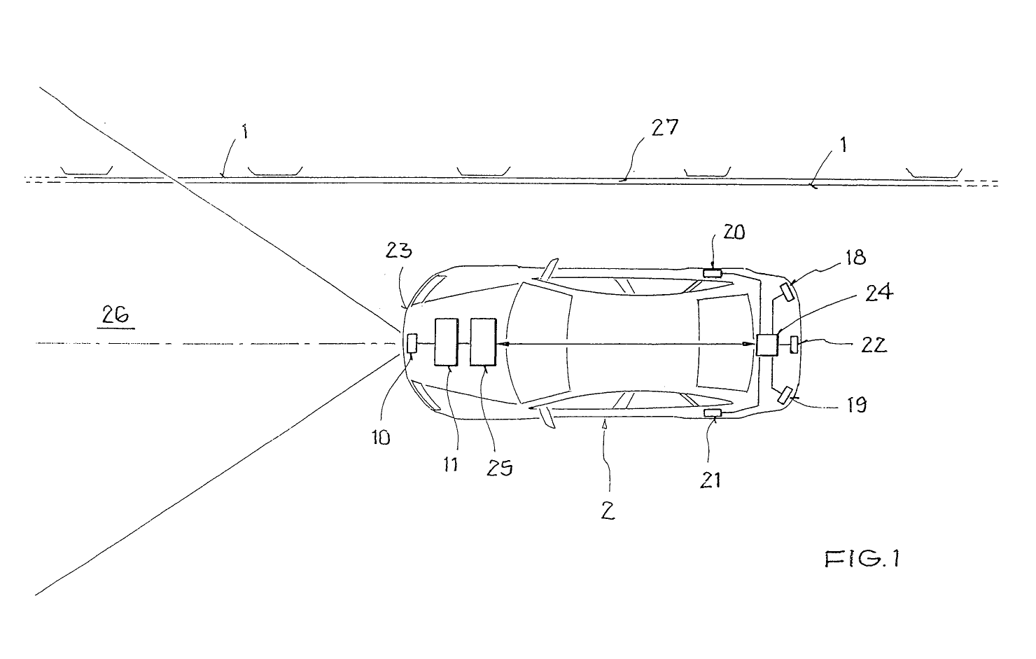

FIG. 1 shows a schematic top view of a vehicle 2 that is equipped for the implementation of the method according to aspects of the invention. For this purpose, the vehicle 2 has a front camera 10 in its front region 23, said front camera 10 illuminating and covering a front detection range 26, wherein long static objects 1, e.g. crash barriers, can be detected by the front camera 10 already. Thus, the front camera 10 delivers its image material to an image processing device 11 that is connected to a logic unit 25. This logic unit integrates an exchange of information between the image processing device 11 and an evaluation unit 24 for RADAR sensors or LIDAR sensors, which evaluation unit 24 is arranged in the rear region of the vehicle.

This evaluation unit 24 evaluates the measured values received from lateral detection devices 20 and 21 as well as 18 and 19 and from at least one rear detection device 22. The image processing device 11 is linked to the evaluation unit 24 via the logic unit 25, which makes the classification of long static objects 1 and thus a classification and distinction between static objects 1 and dynamic objects (essentially made by the RADAR sensors or LIDAR sensors in the lateral and rear detection ranges) more reliable.

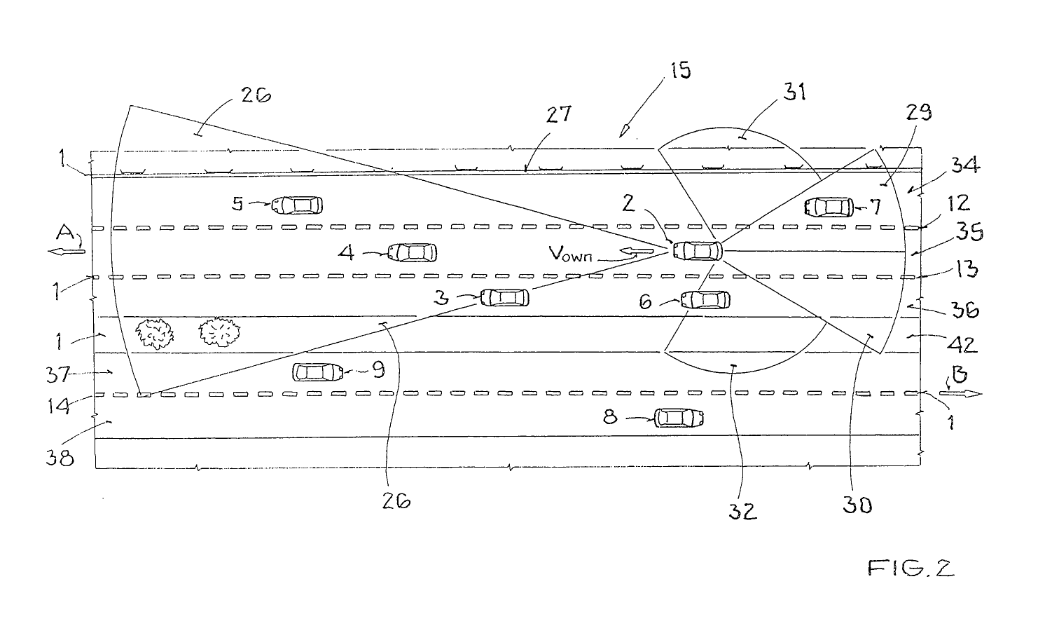

FIG. 2 shows a schematic top view of a road 15 with a vehicle 2 according to FIG. 1. In the direction of traffic A, the road 15 has three traffic lanes 34, 35 and 36 that are separated from each other by road markings 12 and 13 and are demarcated on one side by a crash barrier 27 and on the opposite side by a central reservation 42. The central reservation 42 separates the traffic lanes 34 to 36 of the direction of traffic A from the traffic lanes 37 and 38 of the opposite direction of traffic B. The road markings 12 and 13 in the direction of traffic A and the road marking 14 in the opposite direction of traffic B are among the long static objects 1.

The central reservation 42 and the crash barrier 27 are also among the long static objects. At least as far as the direction of traffic A is concerned, a vehicle 2 driving on the center traffic lane 35 can detect these static objects by means of a front camera 10 (see FIG. 1), since the front camera covers a front detection range 26 in which the other vehicles 3, 4 and 5 are moving in this example and thus represent dynamic targets. An appropriate image processing device that interacts with the front camera detects both the static long objects such as road markings 12 and 13, crash barriers 27 and central reservation 42 and the dynamic objects in the form of the ahead-driving vehicles 3, 4 and 5 and can classify them unambiguously.

On account of the own speed of the vehicle 2, the RADAR-based or LIDAR-based detectors for the blind-spot-monitoring lateral detection ranges 31 and 32 and for the rear detection ranges 29 and 30 are not capable of making the above-mentioned classifications so that it is quite possible that the own speed of the vehicle 2 causes misinterpretations when these radar detection systems measure markings on the crash barriers 27 and/or the passing of the road markings 12 and 13, which means that both the crash barrier 27 and the road markings 12 and 13 as well as trees 28 and shrubs arranged on the central reservation 42 of the roadway may cause false alarms when they enter the detection ranges of the lateral and rear RADAR-based or LIDAR-based detection systems.

By means of the inventive logic device in the vehicle arranged between the front-side image processing unit for the signals of the front camera and the rear-side evaluation unit for RADAR-based or LIDAR-based signals, the detected and classified information, e.g. the objects classified as being static by the front camera, can be included and taken into account in the evaluation of the evaluation unit arranged in the rear region so that the reliability of the warning signals for the driver is significantly increased and improved.

The rear detection ranges 29 and 30 shown here are subdivided into a detection range 29 on the right-hand side and a detection range 30 on the left-hand side. The lateral detection ranges 31 and 32 also cover dynamic objects that appear in the blind spot of the vehicle 2 on the right-hand side or on the left-hand side. Appropriate sensors monitor these detection ranges and may be complemented by further detection ranges that cover more distant objects in the rear range. These lateral and rear detection ranges may overlap in a central detection range 33.

FIG. 2 shows that, by means of the front camera covering the front detection range 26, three dynamic targets (vehicles 3, 4 and 5) are detected and the static objects (the central reservation 42, the two road markings 12 and 13 and the crash barrier 27) are classified as static long objects and can be forwarded via the logic unit of the vehicle to the evaluation unit arranged in the rear region, thereby ensuring that these static objects detected by the front camera do not cause a warning signal.

In this snapshot, the vehicles driving in the opposite direction of traffic B are not covered by the detection ranges of the vehicle 2 yet. The vehicle 6 driving near and next to the vehicle 2 is detected as a dynamic object in the detection range 31, whereas the vehicle 7 is detected as a dynamic target in the more distant lateral range 29. Because of the inventive linking of the front-side image processing device to the rear-side evaluation unit of the vehicle 2, the road markings 12 and 13, the central reservation 42 and the crash barrier 27 can now be detected as static objects reliably and unambiguously in the rear range in spite of the own speed of the vehicle 2 without running the risk of misinterpreting or erroneously classifying them as dynamic objects.

1.-10. (canceled)

11. Method for detecting expansive static objects from a vehicle in motion, wherein
a front camera interacts with an image processing device and detects road markings on a road,
at least one lateral detection device detects objects in a blind spot of the vehicle,
lateral and rear detection devices detect minimal distances to laterally passing or following vehicles,
a logic unit links data of the image processing device of the front camera to data of remaining detection devices in such a manner that expansive static objects in a front detection range of the vehicle are detected and are included as such in the detection of the lateral and rear detection devices using the logic unit.

12. Method according to claim 11, wherein the front camera with image processing distinguishes between oncoming expansive static objects and dynamic objects and marks detected expansive static objects and forwards them for the lateral and rear detection devices to the logic unit.

13. Method according to claim 11, wherein the front camera with image processing detects and forwards the period of time during which the expansive static object is detected and algorithmically tracked.

14. Method according to claim 11, wherein the front camera with image processing detects and forwards horizontal place coordinates of expansive static objects.

15. Method according to claim 11, wherein the front camera with image processing detects and forwards horizontal components of speed regarding expansive static objects.

16. Method according to claim 11, wherein the front camera with image processing detects and forwards classifications regarding expansive static objects.

17. Method according to claim 16, wherein the front camera with image processing detects and forwards surroundings criteria regarding expansive static objects.

18. Method according to claim 11, wherein the detection range of the front camera and the detection ranges of lateral and rear detection devices do not overlap and vehicle-speed-dependent time delays that occur until the detected expansive static objects enter the lateral and rear detection ranges are taken into account by the logic unit.

19. Method according to claim 18, wherein the road markings, crash barriers, walls, fences and sidewalks that enter the lateral and rear detection ranges are detected as long static objects by the front camera with image processing in the front detection range already and are forwarded, by said camera and via the logic unit, for the detection devices that are based on RADAR detection or LIDAR detection in the lateral and rear detection ranges.

20. Method according to claim 18, wherein the logic unit is integrated into an existing vehicle guiding system.
